(19) United States
(12) Patent Application Publication
(10) Pub. No.: US 2025/0360538 A1
(43) Pub. Date: Nov. 27, 2025

(54) Fluid Device Drive Method And Fluid Device

(71) Applicant: SEIKO EPSON CORPORATION, Tokyo (JP)

(72) Inventors: Tatsuki JONAI, Matsumoto (JP); Keita KUBO, Shiojiri (JP); Seiji IZUO, Shiojiri (JP); Hiroto TOMIOKA, Shiojiri (JP)

(21) Appl. No.: 19/217,031

(22) Filed: May 23, 2025

(30) Foreign Application Priority Data
May 27, 2024 (JP) 2024-085845

(51) Int. Cl. B06B 1/02; B01D 43/00

(52) U.S. Cl. CPC B06B 1/0269; B01D 43/00; B06B 2201/70

(57) ABSTRACT

A fluid device drive method for a fluid device including a reference setting step of setting a reference position of a node or an antinode of a standing wave, a first search step of searching within a predetermined range from the reference position for a first frequency of the first standing wave at which a node or an antinode is located, a second search step of searching within the range from the reference position for a second frequency of the second standing wave at which a node or an antinode is located, and a drive step of driving a first ultrasonic element at the first frequency and driving a second ultrasonic element at the second frequency.

The present application is based on, and claims priority from JP Application Serial Number 2024-085845, filed May 27, 2024, the disclosure of which is hereby incorporated by reference herein in its entirety.

### BACKGROUND

### 1. Technical Field

The present disclosure relates to a fluid device drive method and a fluid device.

### 2. Related Art

In the related art, a fluid device that acoustically concentrates fine particles in a fluid is known. For example, in the apparatus disclosed in JP-A-9-122480, ultrasonic waves of specific intensities, specific frequencies, specific phases, or a combination thereof are introduced into a vessel, and the ultrasonic waves are controlled to form a positional potential gradient, thereby moving the fine particles. For example, the fine particles can be collected by using the ultrasonic waves to form a standing wave, moving the fine particles to a position of a node of the standing wave, and introducing a capillary tube to the position of the node to suck up the fine particles.

However, in the fluid device disclosed in JP-A-9-122480, there is a problem that convergence of the fine particles diffused in the vessel is insufficient, and fine particles are likely to be missed. For example, when a fluid is introduced from an inlet into a container in which a positional potential gradient is formed by ultrasonic waves, if the diameter of the flow path differs at the inlet and the inside of the container, the flow velocity component orthogonal to the flow path increases in the container, and thus fine particles become diffused, which may cause a decrease in capturing efficiency.

### SUMMARY

A fluid device drive method according to one aspect of the present disclosure is for a fluid device including an inflow flow path through which fluid flows in a first direction, a separation flow path into which is introduced fluid from the inflow flow path and that is configured to capture fine particles in the fluid using a standing wave, a first outflow flow path through which fluid having a high content of fine particles captured from the separation flow path flows out, a second outflow flow path through which fluid having a low content of fine particles captured from the separation flow path flows out, a first ultrasonic element that is disposed in the inflow flow path and that forms a first standing wave in the inflow flow path in a second direction orthogonal to the first direction, a second ultrasonic element that is disposed in the separation flow path and that forms a second standing wave in the separation flow path in the second direction, the fluid device drive method including execution of a reference setting step of setting a reference position in the second direction of a node or an antinode of a standing wave; a first search step of searching within a predetermined allowable range from the reference position for a first frequency of the first standing wave at which a node or an antinode is located; a second search step of searching within the allowable range from the reference position for a second frequency of the second standing wave at which a node or an antinode is located; and a drive step of driving the first ultrasonic element at the searched first frequency and driving the second ultrasonic element at the searched second frequency.

### BRIEF DESCRIPTION OF THE DRAWINGS

FIG. 1 is a schematic view schematically showing a fluid device according to an embodiment of the present disclosure.

FIG. 2 is a flowchart showing a fluid device drive method according to the embodiment.

FIG. 3 is an enlarged view of a connection section between an inflow flow path and a separation flow path of the fluid device of the embodiment.

FIG. 4 is a diagram showing an example of the relationship between drive frequency of an ultrasonic element and impedance.

FIG. 5 is a diagram showing the relationship between frequency of ultrasonic waves and order of standing waves.

FIG. 6 is a flowchart showing details of a method of determining a drive frequency in step S7 of FIG. 2.

FIG. 7 is a diagram illustrating distance from an ultrasonic wave transmission and reception surface with respect to position of a node counted from the ultrasonic wave transmission surface in the case where a capture position is a node.

FIG. 8 is a diagram showing distance from an ultrasonic wave transmission and reception surface with respect to position of an antinode counted from the ultrasonic wave transmission surface in the case where a capture position is an antinode.

FIG. 9 is a schematic view showing an example of a fluid device according to a third modification.

FIG. 10 is a schematic view showing another example of the fluid device according to the third modification.

FIG. 11 is a schematic view showing an example of a fluid device according to a fourth modification.

### DESCRIPTION OF EMBODIMENT

Hereinafter, an embodiment of the present disclosure will be described with reference to the drawings.

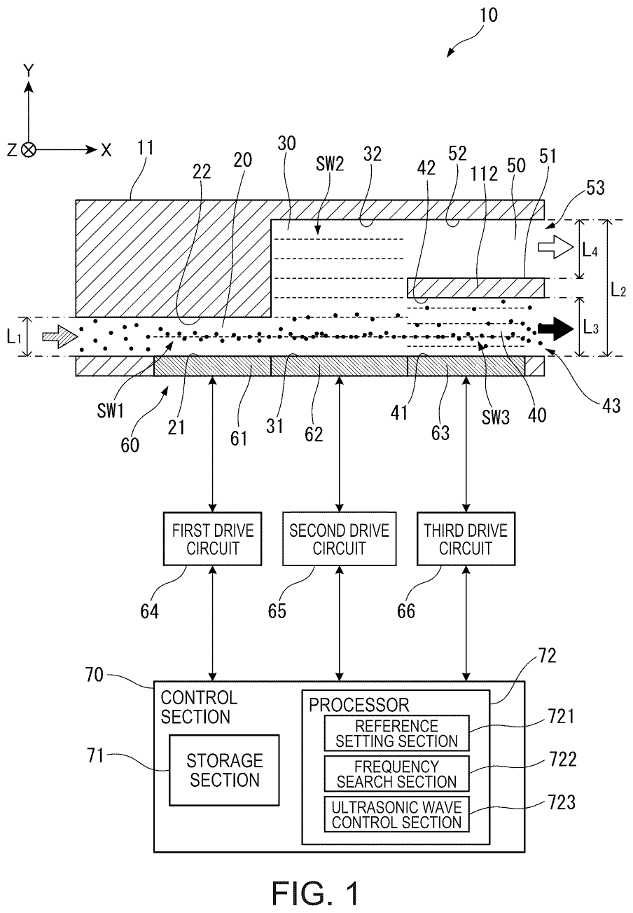

FIG. 1 is a schematic view schematically showing a fluid device 10 of the present embodiment. As shown in FIG. 1, the fluid device 10 includes an inflow flow path 20, a separation flow path 30, a first outflow flow path 40, a second outflow flow path 50, an ultrasonic wave transmission section 60, and a controller 70.

The fluid device 10 of the present embodiment acoustically converges fine particles in a fluid flowing from the inflow flow path 20 into the separation flow path 30, causes the fluid in which fine particles are concentrated to flow out from the first outflow flow path 40, and causes the fluid in which the fine particles are diluted or removed to flow out from the second outflow flow path 50. The fluid is not particularly limited, but may be any liquid such as water. The fine particles are not particularly limited, but are, for example, fine fibers or microplastic.

In the present embodiment, the flow paths of the inflow flow path 20, the separation flow path 30, the first outflow flow path 40, and the second outflow flow path 50 are arranged along an optional single direction, and allow the fluid to flow along the single direction. Here, the flow direction (a first direction of the present disclosure) of fluid in the flow paths is set as an X direction, an upstream side in the flow direction of the fluid is set as a −X side, and a downstream side in the flow direction of the fluid is set as a +X side. A direction (a second direction of the present disclosure) that is orthogonal to the X direction and in which standing waves SW1 to SW3 (to be described later) are formed is set as a Y direction, one side in the Y direction is set as a −Y side, and the other side in the Y direction is set as a +Y side. A direction orthogonal to both the X direction and the Y direction is defined as a Z direction.

In the present embodiment, the entire flow path including the inflow flow path 20, the separation flow path 30, the first outflow flow path 40, and the second outflow flow path 50 is mainly formed by a flow path member 11. The flow path member 11 is constructed from a material capable of reflecting ultrasonic waves in the fluid, for example, a material with an acoustic impedance different from that of the fluid.

The inflow flow path 20 is a flow path through which a fluid containing fine particles flows into the separation flow path 30. The −X side end portion of the inflow flow path 20 is connected to an introduction pipe (not shown) for introducing a fluid into the fluid device 10, and the +X side end portion of the inflow flow path 20 is connected to the −X side end portion of the separation flow path 30. The flow path width L₁ of the inflow flow path 20 in the Y direction is defined by a pair of flat wall surfaces 21, 22 that face each other in the Y direction.

The separation flow path 30 is an intermediate flow path through which the fluid flowing in from the inflow flow path 20 flows out to each of the first outflow flow path 40 and the second outflow flow path 50. The flow path width L₂ of the separation flow path 30 in the Y direction is defined by a pair of flat wall surfaces 31, 32 that face each other in the Y direction. The flow path width L₂ of the separation flow path 30 is larger than the flow path width L₁ of the inflow flow path 20. The wall surface 31 on the −Y side of the separation flow path 30 is continuous in the X direction with the wall surface 21 on the −Y side of the inflow flow path 20.

Both the first outflow flow path 40 and the second outflow flow path 50 are flow paths that cause fluid to flow out from the separation flow path 30, and are both connected with the +X side end portion of the separation flow path 30 in parallel with each other in the Y direction.

The first outflow flow path 40 is disposed at a position facing the inflow flow path 20 in the X direction with the separation flow path 30 interposed therebetween. In other words, the Y-direction range in which the inflow flow path 20 is disposed is included in the Y-direction range in which the first outflow flow path 40 is disposed.

The +X side end portion of the first outflow flow path 40 forms a concentration port 43 from which the fluid flowing in from the separation flow path 30 flows out. The flow path width L₃ of the first outflow flow path 40 in the Y direction is defined by a pair of flat wall surfaces 41, 42 that face each other in the Y direction. The flow path width L₃ of the first outflow flow path 40 is larger than the flow path width L₁ of the inflow flow path 20 and smaller than the flow path width L₂ of the separation flow path 30. A wall surface 41 of the first outflow flow path 40 on the −Y side is continuous in the X direction with the wall surface 31 on the −Y side of the separation flow path 30. In the present embodiment, an example in which L₁<L₃ is described, but this is not a limitation. As will be described in detail later, in the present embodiment, the fine particles in the fluid are trapped at positions of nodes or antinodes of the standing waves in the Y direction, and are caused to flow to the downstream side while being substantially maintained at the capture positions. Therefore, for example, the flow path width L₃ of the first outflow flow path 40 may be equal to the flow path width L₁ of the inflow flow path 20, or may be smaller than the flow path width L₁ of the inflow flow path 20. In particular, by setting the frequency of the ultrasonic waves output from a second ultrasonic element 62 to be larger than the frequency of the ultrasonic waves of a first ultrasonic element 61, it is possible to suppress movement of the fine particles in the Y direction.

The second outflow flow path 50 is disposed closer to the +Y side than is the first outflow flow path 40. The +X side end portion of the second outflow flow path 50 forms a purification port 53 through which fluid flowing in from the separation flow path 30 flows out. The flow path width L₄ of the second outflow flow path 50 is defined by a pair of flat wall surfaces 51, 52 that face each other in the Y direction.

The first outflow flow path 40 and the second outflow flow path 50 are partitioned from each other by a partition section 112. In other words, the flow path member 11 includes the partition section 112 that partitions the first outflow flow path 40 and the second outflow flow path 50 from each other. The partition section 112 forms a wall surface 42 on the +Y side of the first outflow flow path 40 and a wall surface 51 on the −Y side of the second outflow flow path 50.

In the present embodiment, the sum dimension of the flow path width L₃ of the first outflow flow path 40, the flow path width L₄ of the second outflow flow path 50, and the dimension of the partition section 112 in the Y direction, is equal to the flow path width L₂ of the separation flow path 30.

The ultrasonic wave transmission section 60 includes the first ultrasonic element 61 disposed in the inflow flow path 20, the second ultrasonic element 62 disposed in the separation flow path 30, and a third ultrasonic element 63 disposed in the first outflow flow path 40. The ultrasonic wave transmission section 60 includes a first drive circuit 64 that controls drive of the first ultrasonic element 61, a second drive circuit 65 that controls drive of the second ultrasonic element 62, and a third drive circuit 66 that controls drive of the third ultrasonic element 63.

In the present embodiment, the ultrasonic wave transmission surface of the first ultrasonic element 61 constitutes a part of the wall surface 21 of the inflow flow path 20. The ultrasonic wave transmission surface of the second ultrasonic element 62 constitutes a part of the wall surface 31 of the separation flow path 30. The ultrasonic wave transmission surface of the third ultrasonic element 63 constitutes a part of the wall surface 41 of the first outflow flow path 40.

In the present embodiment, an example is shown in which the transmission and reception surfaces of the first ultrasonic element 61, the second ultrasonic element 62, and the third ultrasonic element 63 constitute the wall surfaces 21, 31, 41, but this is not a limitation, and at least one of the first ultrasonic element 61, the second ultrasonic element 62, and the third ultrasonic element 63 may be disposed to outside of the wall surfaces 21, 31, 41. In this case, the ultrasonic waves may be propagated in the fluid through wall surfaces 21, 31, 41.

The specific configuration of each of the ultrasonic elements 61, 62, 63 of the ultrasonic wave transmission section 60 is not particularly limited. For example, the ultrasonic elements 61, 62, 63 may be bulk-type ultrasonic elements or thin-film-type ultrasonic elements. A bulk-type ultrasonic element is an element that vibrates a bulk-type piezoelectric body in response to an input signal and outputs ultrasonic waves by the vibration of the piezoelectric body. A thin-film-type ultrasonic element includes a substrate in which one or more opening sections are formed, a thin-film-shaped vibration section that covers each opening section of the substrate, and a piezoelectric film disposed in each vibration section, and is an element that expands and contracts the piezoelectric film by an input signal to vibrate the vibration section and outputs ultrasonic waves by vibration of the vibration section.

In the present embodiment, the ultrasonic waves transmitted from the first ultrasonic element 61 form a first standing wave SW1 in the inflow flow path 20 in the Y direction. The ultrasonic waves transmitted from the second ultrasonic element 62 form a second standing wave SW2 in the Y direction in the separation flow path 30. The ultrasonic waves transmitted from the third ultrasonic element 63 form a third standing wave SW3 in the first outflow flow path 40 in the Y direction.

The first ultrasonic element 61, the second ultrasonic element 62, and the third ultrasonic element 63 are provided so as to be capable of changing the frequency of the ultrasonic waves they transmit.

Under control of the controller 70, the first drive circuit 64 causes the first ultrasonic element 61 to output ultrasonic waves to form the first standing wave SW1. The first drive circuit 64 changes the frequency (first frequency) of the ultrasonic waves output from the first ultrasonic element 61 to change the order (positions of antinodes and nodes) of the first standing wave SW1.

Similarly, under control of the controller 70, the second drive circuit 65 causes the second ultrasonic element 62 to output ultrasonic waves to form the second standing wave SW2. The second drive circuit 65 changes the order (positions of antinodes and nodes) of the second standing wave SW2 by changing the frequency (second frequency) of the ultrasonic waves output from the second ultrasonic element 62.

Similarly, under the control of the controller 70, the third drive circuit 66 causes the third ultrasonic element 63 to output ultrasonic waves to form the third standing wave SW3. The third drive circuit 66 changes the order (positions of antinodes and nodes) of the third standing wave SW3 by changing the frequency (third frequency) of the ultrasonic waves output from the third ultrasonic element 63.

In FIG. 1, the nodes of the standing waves SW1 to SW3 are indicated in dotted line (lines parallel to the X direction), and the fine particles in the fluid are indicated by black circles.

As described above, the controller 70 controls drive of the first ultrasonic element 61, the second ultrasonic element 62, and the third ultrasonic element 63 via the first drive circuit 64, the second drive circuit 65, and the third drive circuit 66.

The controller 70 is configured by a general computer and, as illustrated in FIG. 1, includes a storage section 71 that stores a program and various data, and a processor 72 that realizes predetermined functions by reading and executing the program stored in the storage section 71.

As shown in FIG. 1, the processor 72 functions as a reference setting section 721, a frequency search section 722, and an ultrasonic wave controller 723 by reading and executing the program stored in the storage section 71.

The reference setting section 721 sets a position (reference position) in the Y direction at which the fine particles in the fluid are to be captured. As the reference position, a position input by the user may be acquired, or the reference position may be stored in the storage section 71 in advance and the reference setting section 721 may read the reference position from the storage section 71 to set the reference position.

The frequency search section 722 sets the frequency of the standing waves SW1, SW2, SW3, which have nodes or antinodes for capturing fine particles, to within a predetermined allowable range from the reference position.

The frequency search section 722 individually sets the frequency of the first ultrasonic element 61, of the second ultrasonic element 62, and of the third ultrasonic element 63. The frequency search section 722 searches for the first frequency of the first standing wave SW1 at which the difference (first deviation amount) between the reference position and the positions of the nodes or antinodes of the first standing wave SW1 formed by the first ultrasonic element 61 is equal to or less than a predetermined first reference deviation amount E₁. When there are plural frequencies at which the first deviation amount is equal to or smaller than the first reference deviation amount E₁, then, for example, the frequency at which the order of the first standing wave SW1 is the smallest may be set as the first frequency, or the frequency of the first standing wave SW1 at which the first deviation amount is the smallest may be set as the first frequency.

The first reference deviation amount may be a value arbitrarily set by the user, for example. That is, the first reference deviation amount is a value indicating to what extent the capture position of the fine particles is allowed with respect to the reference position.

The frequency search section 722 searches for the second frequency of the second standing wave SW2 at which the difference (second deviation amount) between the positions of nodes or antinodes of the second standing wave SW2 formed by the second ultrasonic element 62 and the positions of the antinodes or nodes of the first standing wave SW1 is equal to or less than a predetermined second reference deviation amount E₂. When there are plural frequencies at which the second deviation amount is equal to or smaller than the second reference deviation amount E₂, then, for example, the frequency at which the order of the second standing wave SW2 is minimum may be set as the second frequency, or the frequency of the second standing wave SW2 at which the second deviation amount is minimum may be set as the second frequency.

The second reference deviation amount E₂ is desirably set based on the wavelength (first wavelength λ₁) of the ultrasonic waves forming the first standing wave SW1. That is, in the present embodiment, while the fine particles that were captured at the position of the nodes or antinodes of the first standing wave SW1 in the inflow flow path 20 are flowing into the separation flow path 30 with the flow of the fluid, the fine particles are continuously captured at substantially the same positions in the Y direction. Therefore, it is desirable to make the positions of the nodes or antinodes of the first standing wave SW1 and the second standing wave SW2 as close as possible. When the nodes or antinodes of the second standing wave SW2 are equal to or larger than λ₁/8 with respect to the positions of the nodes or antinodes of the first standing wave SW1 in the Y direction, then, for example, the positions of the nodes of the first standing wave SW1 are highly likely to be in the vicinity of the positions of the antinodes of the second standing wave SW2 in the Y direction. Therefore, the second standing wave SW2 is desirably formed such that the nodes or antinodes of the second standing wave SW2 are formed at positions less than λ₁/8 with respect to the positions of the nodes or antinodes near the reference position of the first standing wave SW1, and more desirably formed at positions less than λ₁/10 with respect to the positions of the nodes or antinodes near the reference position of the first standing wave SW1. Therefore, in the present embodiment, E₂=0.1λ₁ is set as the second reference deviation amount E₂. By this, the positions of the nodes of the second standing wave SW2 in the Y direction are substantially the same as the positions of the nodes of the first standing wave SW1.

Further, the frequency search section 722 searches for the third frequency of the third standing wave SW3 in which the difference (third deviation amount) between the positions of the nodes or antinodes of the third standing wave SW3 formed by the third ultrasonic element 63 and the positions of the antinodes or nodes of the second standing wave SW2 is equal to or less than a predetermined third reference deviation amount E₃. When there are plural frequencies at which the third deviation amount is equal to or smaller than the third reference deviation amount E₃, then, for example, the frequency at which the order of the third standing wave SW3 is the smallest may be set as the third frequency or the frequency of the third standing wave SW3 at which the third deviation amount is the smallest may be set as the third frequency.

The third reference deviation amount E₃ is set similarly to the setting of the second reference deviation amount E₂ with respect to the first wavelength λ₁. That is, E₃=0.1λ₂ is set based on the wavelength (second wavelength λ₂) of the ultrasonic waves that form the second standing wave SW2. By this, the positions in the Y direction of the nodes of the third standing wave SW3 are substantially the same as the positions of the nodes of the second standing wave SW2.

The ultrasonic wave controller 723 drives the ultrasonic elements 61, 62, 63 at the frequency that was searched and determined by the frequency search section 722.

### Operation of Fluid Device 10

Next, a drive method of the fluid device 10 of the present embodiment will be described.

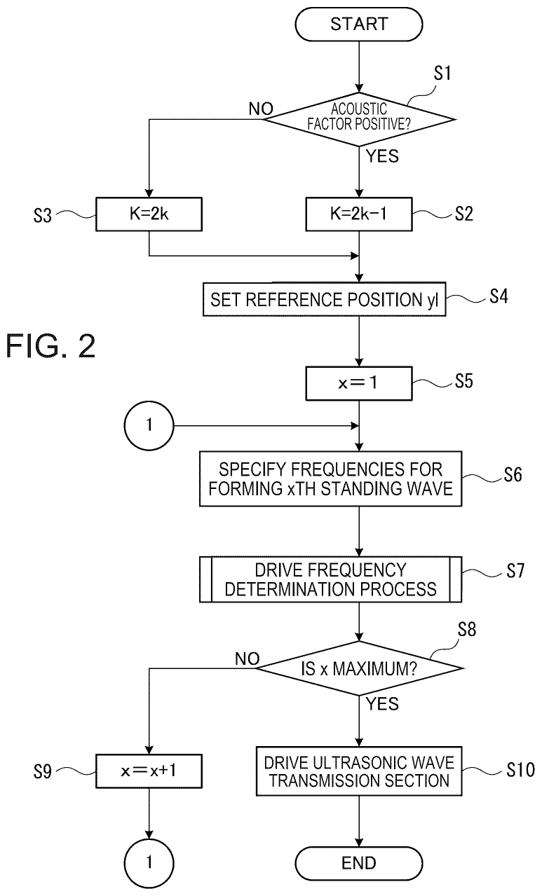

FIG. 2 is a flowchart showing a drive method of the fluid device 10 of the present embodiment.

In the fluid device 10 according to this embodiment, it is determined whether or not the acoustic factor of the fine particles to be trapped in the fluid is positive (step S1). The acoustic factor is determined by the compression ratio, the density ratio, and the like between the fine particles and the medium in the sound field, and when the acoustic factor is positive, then the fine particles are captured at positions of the nodes of the standing waves SW1, SW2, SW3, and when the acoustic factor is negative, then the fine particles are captured at positions of the antinodes of the standing waves SW1, SW2, SW3. The controller 70 determines whether the acoustic factor is positive or negative based on an input operation of the user.

For example, when the user inputs that the acoustic factor is positive, the controller 70 determines YES in step S1, and sets a capture variable K to K=2k−1 (step S2).

On the other hand, when the user inputs that the acoustic factor is negative, the controller 70 determines NO in step S1, and sets the capture variable K to K=2k (step S3).

The capture variable K is a variable indicating the position of a node or an antinode counted from the ultrasonic wave transmission surface of the ultrasonic wave transmission section 60. The equation K=2k−1 indicates the position of a node when the positions of the nodes or antinodes of the standing waves SW1, SW2, SW3 are sequentially counted from the transmission surface of the ultrasonic waves. The equation K=2k indicates the position of an antinode when the positions of the nodes or antinodes of the standing waves SW1, SW2, SW3 are sequentially counted from the transmission surface of the ultrasonic waves.

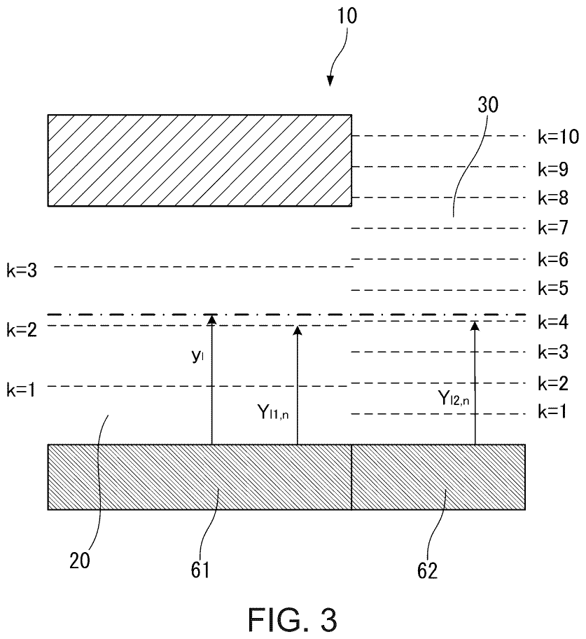

Next, the reference setting section 721 of the controller 70 sets a reference position y₁ (step S4). FIG. 3 is an enlarged view of the connection section between the inflow flow path 20 and the separation flow path 30 of the fluid device 10 of the present embodiment. In FIG. 3, an alternate long and short dash line indicates the reference position y₁, and broken lines indicate positions of nodes of the first standing wave SW1 and of the second standing wave SW2. Note that in the example of FIG. 3, it is assumed that the acoustic factor is positive and that the fine particles are captured at positions of nodes.

As described above, the reference position y₁ is an approximate position within the fluid device 10 where the fine particles contained in the fluid are converged, and can be arbitrarily set by the user. That is, as described above, the reference position y₁ may be set by acquiring the reference position y₁ input by the user, or may be set by reading the reference position y₁ recorded in the storage section 71 in advance.

Next, the frequency search section 722 searches for the frequencies of the ultrasonic elements 61, 62, 63. To do this, first, the frequency search section 722 initializes an element variable x that indicates the ultrasonic elements 61, 62, 63 to x=1 (step S5). Note that x=1 indicates the first ultrasonic element 61, x=2 indicates the second ultrasonic element 62, and x=3 indicates the third ultrasonic element 63.

The frequency search section 722 performs a frequency sweep with respect to the ultrasonic element that corresponds to the element variable x, measures the impedance of the ultrasonic element, and specifies a plurality of frequencies at which standing waves can be formed (step S6).

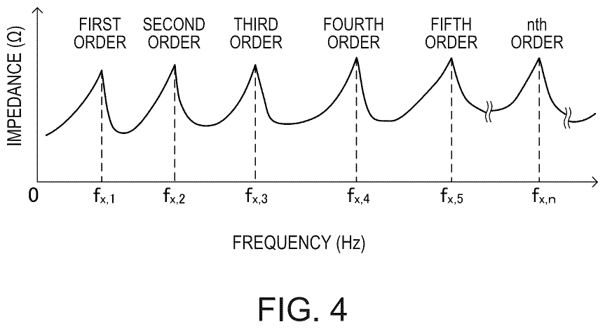

FIG. 4 is a diagram showing an example of the relationship between the impedance and the drive frequency of the ultrasonic element. When standing waves are formed in the flow path, the position of the ultrasonic wave transmission surface of the ultrasonic element becomes an antinode, and thus the impedance of the ultrasonic element becomes the maximum. Therefore, the frequency at which the standing waves are formed can be specified by measuring the impedance and specifying the frequency at which the impedance takes the maximum value. Note that in FIG. 4, n represents the order, and f_{x, n} represents the frequency of the ultrasonic waves when the ultrasonic element corresponding to the element variable x forms a standing wave of the order n. In the actual fluid device 10, there is a limit to the variable range of the frequency of the ultrasonic waves that can be transmitted by the ultrasonic element, and there is also a limit to the orders of standing waves that can be formed. However, here, in order to facilitate description, an example will be described in which standing waves can be formed from a first-order standing wave.

For example, in a case of x=1, ultrasonic waves are transmitted from the first ultrasonic element 61, the frequency of the ultrasonic waves is swept, and the impedance related to the first ultrasonic element 61 is measured. In a case where the first standing wave SW1 is formed in the inflow flow path 20, the impedance of the first ultrasonic element 61 has a maximum value. Therefore, by sweeping the frequencies of the first ultrasonic element 61, it is possible to specify the plurality of frequency f_{1, n} forming the first standing wave SW1.

Note that when the presence or absence of the formation of a standing wave is determined by measurement of impedance, it is desirable to use a thin-film-type ultrasonic element as each of the ultrasonic elements 61, 62, 63. In the case of using a bulk-type ultrasonic element, a pressure sensor (or a strain sensor) that measures the sound pressure of the ultrasonic waves may be provided on the wall surfaces 21, 31, 41, and the frequency f_{x, n} of the ultrasonic waves at which the pressure measured by the pressure sensor becomes the maximum value may be specified.

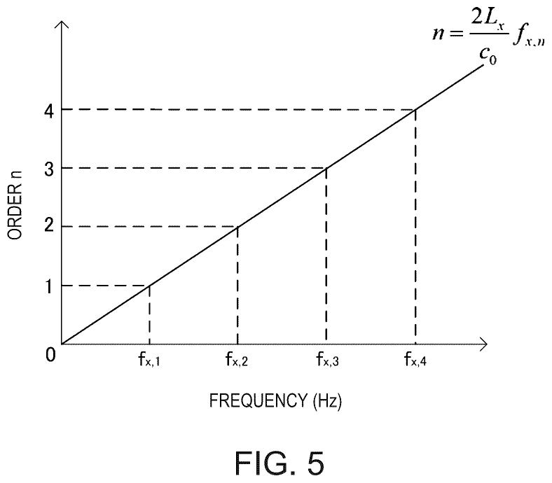

FIG. 5 is a diagram showing the relationship between the frequency f_{x, n} of the ultrasonic waves and the order n of the standing waves.

The relationship between the frequency f_{x, n} of the ultrasonic waves capable of forming standing waves and the mode order is as shown in the following Equation (1), and is a proportional relationship as shown in FIG. 5.

$$Equation ( 1 )$$

$$n = \frac{2 {L}_{x}}{{c}_{0}} {f}_{x , n} \qquad ( 1 )$$

In Equation (1), c₀ denotes the speed of sound in the fluid. Lx is the flow path width of the fluid device 10 in the ultrasonic element of the element variable x. When x=1 indicating the first ultrasonic element 61, then the flow path width L₁ of the inflow flow path 20 is shown, when x=2 indicating the second ultrasonic element 62, then the flow path width L₂ of the separation flow path 30 is shown, and when x=3 indicating the third ultrasonic element 63, then the flow path width L₃ of the first outflow flow path 40 is shown. In the present embodiment, the frequency search section 722 specifies the frequencies f_{x, n} of the ultrasonic waves capable of forming the standing waves SW1, SW2, SW3 in the respective ultrasonic elements 61, 62, 63 and the orders of the standing waves SW1, SW2, SW3 when the ultrasonic elements 61, 62, 63 are driven at the frequencies f_{x, n}.

Next, the actual drive frequencies of the ultrasonic elements with respect to the element variable x are determined from the frequencies of the ultrasonic waves capable of forming the standing waves measured in step S6 (step S7).

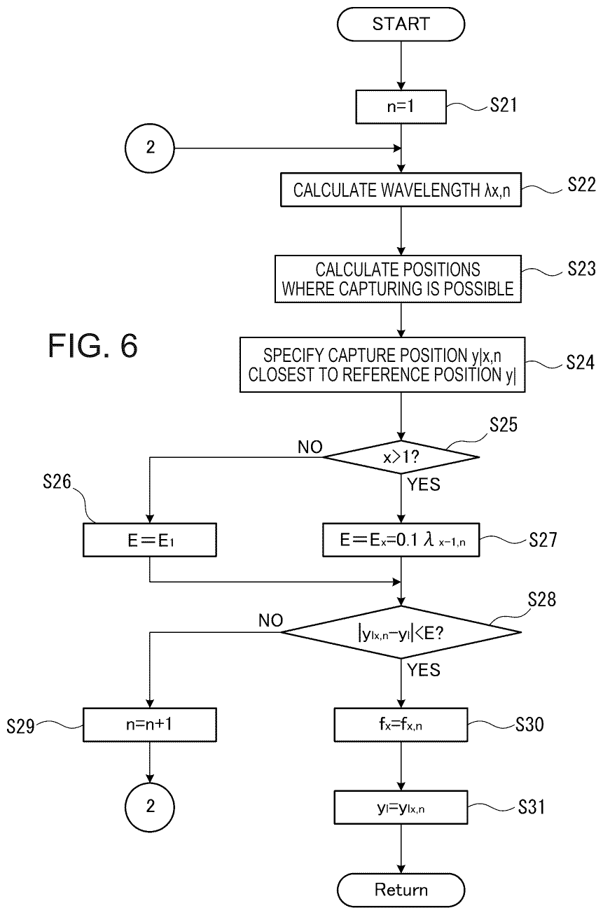

FIG. 6 is a flowchart showing details of the method of determining the drive frequency in step S7.

First, the frequency search section 722 initializes the order n to the minimum value (step S21). In this embodiment, the minimum value is set to n=1 to facilitate explanation.

Next, the frequency search section 722 calculates the wavelength λ_{x, n} of the ultrasonic waves for forming the standing wave of the order n (step S22). The wavelength λ_{x, n} can be determined by the following Equation (2).

$$Equation ( 2 )$$

$${λ}_{x , n} = \frac{2 {L}_{x}}{n} \qquad ( 2 )$$

Next, the position y_{1x, n}, from the ultrasonic wave transmission surface of the ultrasonic element, of a node or an antinode capable of capturing the fine particles is calculated (step S23). When the capture variable K is obtained in step S2, the position of a node corresponding to K=2k−1 (k=1, 2, 3 . . . ) is a position at which fine particles can be captured. When the capture variable K is obtained in step S3, the position of an antinode corresponding to K=2k (k=1, 2, 3 . . . ) is a position at which fine particles can be captured.

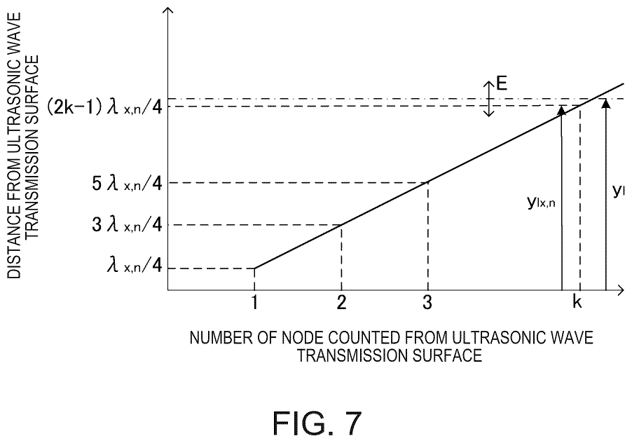

FIG. 7 is a diagram illustrating a distance from the ultrasonic wave transmission surface with respect to positions of nodes counted from the ultrasonic wave transmission surface, in the case where the capture positions are nodes.

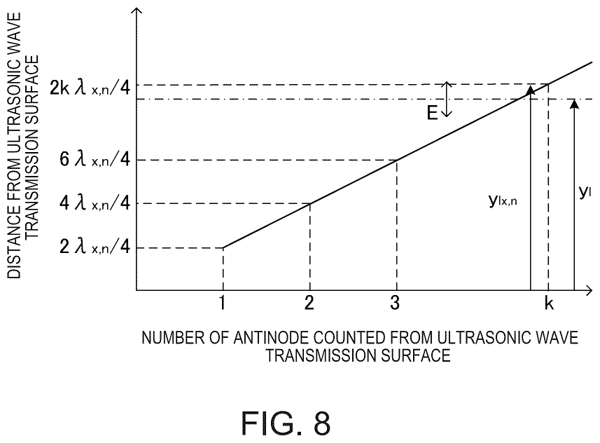

FIG. 8 is a diagram showing the distance from the ultrasonic wave transmission surface with respect to the positions of antinodes counted from the ultrasonic wave transmission surface, in the case where capture positions are antinodes.

That is, the frequency search section 722 calculates the position y_{1x, n} of the node or antinode capable of capturing the fine particles by using the following Equation (3).

$$Equation ( 3 )$$

$${y}_{lx , n} = \frac{K}{4} {λ}_{x , n} \qquad ( 3 )$$

The frequency search section 722 sequentially substitutes k=1, 2, 3 . . . into Equation (3) to calculate the positions y_{1x, n} of the nodes or antinodes capable of capturing fine particles, and specifies the position y_{1x, n} among the calculated positions y_{1x, n} that is closest to the reference position y₁ (step S24). Note that it will be assumed that the node or antinode closest to the reference position y₁ counted from the ultrasonic wave transmission and reception surface is located at the position kx-th.

Next, the frequency search section 722 determines whether or not x>1 (step S25), and when NO (when x=1), sets the allowable deviation amount E to the first reference deviation amount E₁ (step S26).

On the other hand, when YES in step S25 (when x>1), the frequency search section 722 sets the allowable deviation amount E to E=0.1λ_{x-1, n} (step S27). That is, the allowable deviation amount E is set to E=E₂=0.1λ_{1,n} in the frequency setting of the second ultrasonic element 62, and the allowable deviation amount E is set to E=E₃=0.1λ₂, n in the frequency setting of the third ultrasonic element 63. As described above, E₂ is the second reference deviation amount, and E₃ is the third reference deviation amount.

Afterward, the frequency search section 722 determines whether or not the absolute value of the difference between the reference position y₁ and the position y_{1x, n} of the node or antinode closest to the reference position y₁, which was identified in step S24, is less than the allowable deviation amount E (step S28).

If NO is determined in step S28, 1 is added to the order n (step S29), and the process returns to step S22.

If YES is determined in step S28, the frequency search section 722 adopts f_{x, n} as the drive frequency fₓ in the ultrasonic element corresponding to x (step S30). That is, when YES is determined in step S28, the order n of the standing wave to be formed is determined, and the wavelength λₓ of the standing waves is determined to be the wavelength λ_{x, n}. The position y_{1x, n} of the node (or antinode) closest to the reference position y₁ is the capture position of the fine particles in the standing wave formed by the ultrasonic element corresponding to the element variable x. The frequency search section 722 updates the reference position y₁ to the capture position y_{1x, n} (step S31). By this, in the loop in which the element variable is x+1, a search for drive frequencies is performed with the capture position y_{1x, n}, which corresponds to the determined element variable x, as the reference.

After the above, the frequency search section 722 determines whether or not the element variable x is the maximum value (step S8).

When NO is determined in step S8, then 1 is added to the element variable x (step S9), and the process returns to step S6.

When YES is determined in step S8, the search process is ended, and the ultrasonic wave controller 723 drives the ultrasonic wave transmission section 60 (step S10). That is, the ultrasonic wave controller 723 drives the first ultrasonic element 61 at the set drive frequency f1, drives the second ultrasonic element 62 at the set drive frequency f2, and drives the third ultrasonic element 63 at the set drive frequency f3.

By this, as shown in FIG. 1, the fine particles are trapped in the inflow flow path 20, the separation flow path 30, and the first outflow flow path 40 at the capture position within the predetermined allowable range (within the range of E₁+E₂+E₃) from the initially set reference position y₁, and outflow of fine particles to the second outflow flow path 50 is suppressed.

### Operation and Effect of Present Embodiment

The fluid device 10 of the present embodiment includes the inflow flow path 20 through which fluid flows in the X direction (first direction), the separation flow path 30 into which the fluid is introduced from the inflow flow path 20, the first outflow flow path 40 through which fluid with a high content of fine particles flows out from the separation flow path 30, the second outflow flow path 50 through which fluid with a low content of fine particles flows out from the separation flow path 30, and the controller 70. The inflow flow path 20 is provided with the first ultrasonic element 61 that forms the first standing wave SW1 in the Y direction (second direction) orthogonal to the X direction. The separation flow path 30 is provided with the second ultrasonic element 62 that forms the second standing wave SW2 in the separation flow path 30 in the Y direction. The controller 70 performs the reference setting step (step S4) of setting the reference position y₁ of anode or an antinode of the standing wave in the Y direction, the first search step (step S7 in the loop of x=1) of searching for the first frequency f_{11, n} of the first standing wave SW1 whose node or antinode is located within a predetermined allowable range from the reference position y₁, the second search step (step S7 in the loop of x=2) of searching for a second frequency f_{12, n} of the second standing wave SW2 whose node or antinode is located within the predetermined allowable range from the reference position y₁, and the drive step (step S10) of driving the first ultrasonic element 61 at the searched first frequency f_{11, n} and driving the second ultrasonic element 62 at the searched second frequency f_{12, n}.

By this, the behavior of the fine particles immediately before they are trapped at the positions of the nodes or antinodes of the second standing wave SW2 in the separation flow path 30 can be controlled by the first standing wave SW1 formed by the first ultrasonic element 61, thereby improving the efficiency of capturing fine particles. That is, in the present embodiment, when the fine particles captured at the node or antinode of the first standing wave SW1 within the allowable range from the reference position y₁ flow into the separation flow path 30, the fine particles are captured at the node or antinode of the second standing wave SW2 within the allowable range from the reference position y₁. Therefore, although velocity components are generated in the fluid in the Y direction when the fluid flows into the separation flow path 30 from the inflow flow path 20, the fine particles are captured at the position of the node or antinode of the first standing wave SW1 within the allowable range from the reference position y₁ in the inflow flow path 20 and, immediately after flowing into the separation flow path 30 from the inflow flow path 20, are captured at the position of the node or antinode of the second standing wave SW2 that is within the allowable range from the reference position y₁. Therefore, since movement of fine particles in the Y direction is regulated, diffusion is suppressed, efficiency of capturing fine particles is improved, and the fluid having a high fine particle concentration can flow out from the first outflow flow path 40.

In general, a mass-produced fluid device 10 includes minute errors at the time of manufacturing. When an ultrasonic element with a fixed frequency is used, it is difficult to form appropriate standing waves with respect to the flow path width of a fluid device that includes a manufacturing error. Although it is possible to set the drive frequency of the ultrasonic element by measuring the flow path width after manufacturing for each fluid device, there is also a problem that the manufacturing cost increases. The flow path width may vary due to the use environment of the fluid device 10 or due to aging. In these cases, maintenance or replacement is required to form appropriate standing waves. On the other hand, in the present embodiment, regardless of the flow path width of the fluid device 10 and even when a flow path width varies due to the use environment and change over time, the first frequency f_{11, n} and the second frequency f_{12, n} at which the standing waves SW1, SW2 can be formed can be searched and, by this, efficiency of capturing fine particles can be improved and a reduction in capturing efficiency can be suppressed.

In the fluid device 10 of the present embodiment, in step S7 (loop of x=1), the first deviation amount (|y_{11, n}−y₁|), which is a deviation amount between the reference position y₁ and the position of a node or an antinode of the first standing wave SW1, is calculated, and the first frequencies f_{1, n} are searched based on the difference between the first deviation amount and the predetermined first reference deviation amount E₁. That is, the first frequencies f_{11, n} satisfying |y_{11, n}−y₁|<E₁ are searched.

By this, it is possible to search for the first frequency f_{11,n} capable of forming the first standing wave SW1 in which the position of a node or an antinode appears at a position close to the reference position y₁.

In the fluid device 10 of this embodiment, by the first standing wave SW1 formed by the searched first frequency f_{11, n}, the capture position y_{1, n} of the node or antinode close to the reference position y₁ is set as a new reference position y₁. In step S7 (loop of x=2), the second deviation amount |y_{12, n}−y₁|(=|y_{12, n}−y_{1, n}|), which is the deviation amount between the position of the node or antinode of the second standing wave SW2 and the newly set reference position y₁ (that is, the capture position y_{11, n} of the first standing wave SW1 formed at the searched first frequency f_{11, n}), is calculated, and the second frequency f2, n is searched based on a difference between the second deviation amount and the predetermined second reference deviation amount E₂. That is, the second frequencies f_{12, n} satisfying |y_{12, n}−y₁|<E₂ are searched.

By this, it is possible to search for the second frequency f_{12, n} capable of forming the second standing wave SW2 in which the position of a node or an antinode appears at a position close to the capture position where the fine particles are trapped by the first standing wave SW1.

In the fluid device 10 of the present embodiment, the second reference deviation amount E₂ is set based on the wavelength λ_{1, n} of the ultrasonic waves that form the first standing wave SW1.

That is, since the nodes and antinodes of the first standing wave SW1 appear at an interval of λ_{1, n}/8, the capture position y_{12, n} of the fine particles by the second standing wave SW2 is desirably positioned within a range of λ_{1, n}/8 with respect to at least the capture position y_{11, n} of the fine particles by the first standing wave SW1. In the present embodiment, by setting E₂=0.1 λ_{1, n} using the wavelength λ_{1, n} of the ultrasonic waves forming the first standing wave SW1, the capture position y_{11, n} of the fine particles by the first standing wave SW1 and the capture position y_{12, n} of the fine particles by the second standing wave SW2 can be close to each other, and the second standing wave SW2 can be formed so as to suppress the diffusion of the fine particles when they flow from the inflow flow path 20 into the separation flow path 30.

In the fluid device 10 of this embodiment, when the second deviation amount (|y_{12, n}−y₁|) is larger than the second reference deviation amount E₂, the order n of the second standing wave SW2 is increased to search for the second frequencies f_{12, n} in step S29.

By increasing the order n of the second standing wave SW2, it is possible to form the second standing wave SW2 with a smaller interval between nodes or antinodes. Therefore, it is possible to efficiently search for the second standing wave SW2 having a node or an antinode close to the capture position y_{11, n} of the first standing wave SW1.

The fluid device 10 of the present embodiment further includes the third ultrasonic element 63 that forms a third standing wave SW3 in the Y direction in the first outflow flow path 40. Then, the controller 70 further performs the third search step (step S7 in the loop of x=3) of searching for the third frequency f_{13, n} of the third standing wave SW3 with the node or antinode positioned within the allowable range from the reference position y₁, and drives the third ultrasonic element 63 at the third frequency f_{13, n} searched for in step S10.

By this, the fine particles captured at the positions of the nodes or antinodes of the second standing wave SW2 in the separation flow path 30 are directly captured at the positions of the nodes or antinodes of the third standing wave SW3 in the first outflow flow path 40 and flow in the X direction. Therefore, it is possible to suppress the disadvantage of fine particles becoming diffused in the first outflow flow path 40 and the diffused fine particles returning to the separation flow path 30, and it is possible to improve the capturing efficiency of the fine particles.

As in the case of the first standing wave SW1 and the second standing wave SW2, even when the flow path width L₃ of the first outflow flow path 40 includes manufacturing errors or the flow path width L₃ varies due to the use environment or change over time, it is possible to search for the third frequencies at which is formed the appropriate third standing wave SW3 capable of trapping the fine particles.

In the fluid device 10 of this embodiment, in the second standing wave SW2 formed by the searched second frequency f_{12, n}, the position (capture position y_{12, n}) of the node or antinode close to the reference position y₁ is set as a new reference position y₁. In step S7 (loop of x=3), the third deviation amount (|y_{13, n}−y₁|=|y_{13, n}−y_{13, n}|), which is the deviation amount between the position of the node or antinode of the third standing wave SW3 and the newly set reference position y₁ (that is, the capture position y_{12, k} of the second standing wave SW2 formed at the searched second frequency f_{12, n}) is calculated, and the third frequency f_{13, n} is searched based on a difference between the third deviation amount and a predetermined third reference deviation amount E₃. That is, the third frequencies f_{13, n} satisfying |y_{13, n}−y₁|<E₃ are searched.

By this, it is possible to search for the third frequency f_{13, n} capable of forming the third standing wave SW3 in which the position of a node or an antinode appears at a position close to the capture position y_{13, n} where fine particles are trapped by the second standing wave SW2.

In the fluid device 10 of the present embodiment, the third reference deviation amount E₃ is set based on the wavelength λ_{2, n} of the ultrasonic waves forming the second standing wave SW2. That is, E₃=0.1λ_{2, n} is obtained by using the wavelength λ_{2, n} of the ultrasonic waves forming the second standing wave SW2.

By this, the capture position y_{12, n} of the fine particles by the second standing wave SW2 and the capture position y_{13, n} of the fine particles by the third standing wave SW3 can be close to each other, and the third standing wave SW3 can be formed so as to suppress the diffusion of the fine particles when the fine particles flow into the first outflow flow path 40 from the separation flow path 30.

### MODIFICATIONS

The present disclosure is not limited to the above-described embodiments, and configurations obtained by modifications, improvements, appropriate combinations of the embodiments, and the like within a range in which the object of the present disclosure can be achieved are included in the present disclosure.

### First Modification

In the embodiment described above, an example in which the ultrasonic wave transmission section 60 including the first ultrasonic element 61, the second ultrasonic element 62, and the third ultrasonic element 63 is provided in the fluid device 10 has been described, but the third ultrasonic element 63 may not be provided.

That is, even if the third ultrasonic element 63 is not provided, in the separation flow path 30 from the inflow flow path 20, the fine particles are captured at the capture position (node or antinode) located within the predetermined allowable range from the reference position y₁, and move to the first outflow flow path 40 along the flow of the fluid. Therefore, the third ultrasonic element 63 is not necessarily required.

Note that by providing the third ultrasonic element 63 as in the embodiment described above, movement of the fine particles in the Y direction in the first outflow flow path 40 is suppressed, so it is possible to suppress the disadvantage of fine particles that moved from the first outflow flow path 40 to the +Y side flowing back to the separation flow path 30.

### Second Modification

In the above-described embodiment, it is determined in steps S25 to S28 whether or not the absolute value of the difference between the capture position y_{1x, n} at which the fine particles are trapped by the standing wave and the reference position y₁ is less than the allowable deviation amount E, but this is not a limitation.

For example, the frequency f_{x, n} at which y₁−y_{1x, n}>E may be set as the drive frequency fx. In this case, the capture position y_{12, n} of fine particles at the node (or antinode) of the second standing wave SW2 in the separation flow path 30 is located further to the −Y side with respect to the capture position y_{11, n} of fine particles at the node (or antinode) of the first standing wave SW1 in the inflow flow path 20. The same applies to the movement of fine particles from the separation flow path 30 to the first outflow flow path 40, and the fine particles move closer to the −Y side. Therefore, when the fine particles move from the inflow flow path 20, through the separation flow path 30, and to the first outflow flow path 40, the fine particles flow away from the second outflow flow path 50. By this, it is possible to further suppress the disadvantage of the fine particles flowing to the +Y side (the second outflow flow path 50 side), and it is possible to increase the concentration of fine particles in the fluid that flows out from the first outflow flow path 40.

### Third Modification

In the above-described embodiment, an example in which all of the first ultrasonic element 61, the second ultrasonic element 62, and the third ultrasonic element 63 are disposed on the −Y side in the flow path is described, but at least one of them may be positioned on the +Y side.

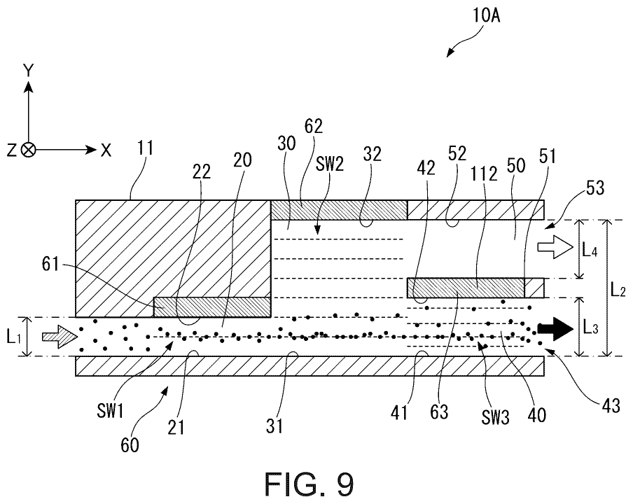

FIG. 9 is a schematic view showing an example of a fluid device 10A according to the third modification. Note that in FIG. 9, the first drive circuit 64, the second drive circuit 65, the third drive circuit 66, and the controller 70 are not shown.

For example, as shown in FIG. 9, the first ultrasonic element 61 may be provided on the wall surface 22 on the +Y side of the inflow flow path 20. The second ultrasonic element 62 may be provided on the wall surface 32 on the +Y side of the separation flow path 30. The third ultrasonic element 63 may be provided on the wall surface 42 on the +Y side of the first outflow flow path 40.

In FIG. 9, all of the first ultrasonic element 61, the second ultrasonic element 62, and the third ultrasonic element 63 are disposed on the +Y side of the flow path, but a configuration may be adopted in which at least one of them is disposed on the +Y side of the flow path, and the rest are disposed on the −Y side.

A configuration may be adopted in which at least one of the first ultrasonic element 61, the second ultrasonic element 62, and the third ultrasonic element 63 is provided on both ±Y sides of the flow path.

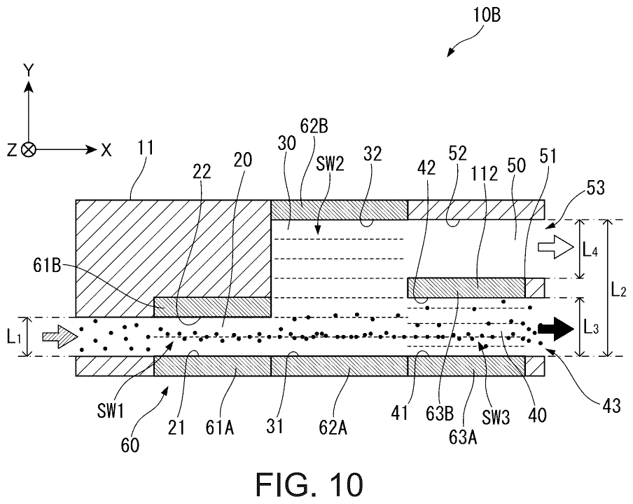

FIG. 10 is a view showing another example of a fluid device 10B according to the third modification.

As shown in FIG. 10, first ultrasonic elements 61A, 61B may be provided on the wall surfaces 21 and 22 on the ±Y sides of the inflow flow path 20, respectively. In this case, it is possible to form the first standing wave SW1 by driving the first ultrasonic element 61A and the first ultrasonic element 61B at the same drive frequency f1 and shifting the drive periods of the first ultrasonic element 61A and the first ultrasonic element 61B by a half cycle.

The same applies to second ultrasonic elements 62A and 62B and third ultrasonic elements 63A and 63B.

### Fourth Modification

In the described embodiment, an example is provided where the wall surface 21 on the −Y side of the inflow flow path 20, the wall surface 31 on the −Y side of the separation flow path 30, and the wall surface 41 on the −Y side of the first outflow flow path 40 are continuous, but this is not a limitation.

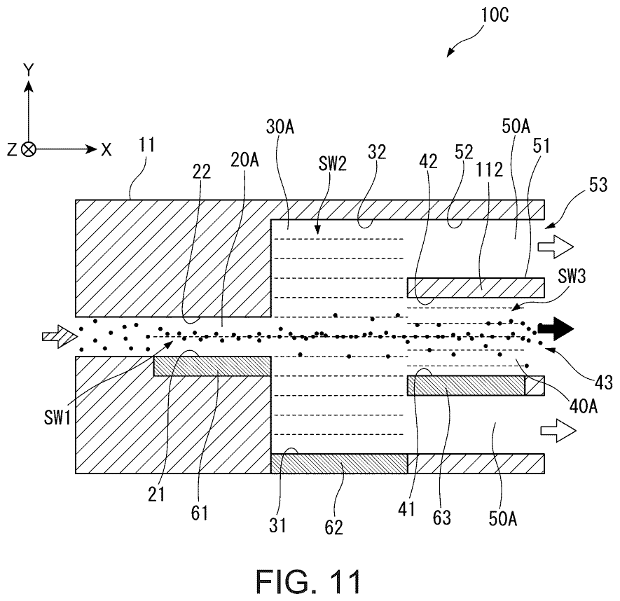

FIG. 11 is a diagram showing an example of the fluid device 10C according to a fourth modification.

For example, as shown in FIG. 11, an inflow flow path 20A may be connected to the center of a separation flow path 30A. In this case, a first outflow flow path 40A is opposed to the inflow flow path 20A and is connected to the center of the separation flow path 30A. In order to make the flow distribution in the Y direction in the separation flow path 30A symmetrical, it is desirable to provide second outflow flow paths 50A having the same flow path size on both ±Y sides of the first outflow flow path 40A.

In FIG. 11, the first ultrasonic element 61 is provided on the −Y side of the inflow flow path 20A, the second ultrasonic element 62 is provided on the −Y side of the separation flow path 30A, and the third ultrasonic element 63 is provided on the −Y side of the first outflow flow path 40, but this is not a limitation. As described in the third modification, the arrangement positions of the ultrasonic elements 61, 62, 63 may be on the +Y side of the flow paths, or may be provided on both of the ±Y sides.

### Fifth Modification

In the embodiment described above, an upper limit value of the drive frequency of each of the ultrasonic elements 61, 62, 63 may be set. For example, when fine fibers are used as the fine particles, the frequencies of the ultrasonic elements 61, 62, 63 are set to be equal to or less than (sound speed in fluid)/(4×fiber length). In this case, the fiber length direction of the fine fibers can be made substantially parallel to the X direction in which the fluid flows, and clogging of the fine fibers in the flow path can be suppressed.

When fine fibers are separated as fine particles, it is desirable that the drive frequency f₂ of the second ultrasonic element 62 corresponding to the separation flow path 30 be at least larger than the drive frequency f₁ of the first ultrasonic element 61. In this case, the acoustic radiation force increases with respect to the separation flow path 30 having a flow path width larger than that of the inflow flow path 20, and the region of the near acoustic field where the density of acoustic waves is high can be widened.

By this, even when the fine particles are fine fibers, the fine fibers can be efficiently captured and caused to flow into the first outflow flow path 40.

### Summary of the Present Disclosure

The fluid device drive method according to the first aspect of the present disclosure is for a fluid device including an inflow flow path through which fluid flows in a first direction, a separation flow path into which is introduced fluid from the inflow flow path and that is configured to capture fine particles in the fluid using a standing wave, a first outflow flow path through which fluid having a high content of fine particles captured from the separation flow path flows out, a second outflow flow path through which fluid having a low content of fine particles captured from the separation flow path flows out, a first ultrasonic element that is disposed in the inflow flow path and that forms a first standing wave in the inflow flow path in a second direction orthogonal to the first direction, a second ultrasonic element that is disposed in the separation flow path and that forms a second standing wave in the separation flow path in the second direction, the fluid device drive method including execution of a reference setting step of setting a reference position in the second direction of a node or an antinode of a standing wave; a first search step of searching within a predetermined allowable range from the reference position for a first frequency of the first standing wave at which a node or an antinode is located; a second search step of searching within the allowable range from the reference position for a second frequency of the second standing wave at which a node or an antinode is located; and a drive step of driving the first ultrasonic element at the searched first frequency and driving the second ultrasonic element at the searched second frequency.

By this, it is possible to control the behavior of the fine particles immediately before the fine particles are trapped at the position of the node or antinode of the standing wave in the separation flow path, and it is possible to improve the trapping efficiency of fine particles. The flow path widths of the inflow flow path and the separation flow path may include a minute error when the fluid device is manufactured. In this case, due to the minute error in the flow path width, the first standing wave and the second standing wave that are appropriate for capturing fine particles cannot be formed, and the capture efficiency decreases. In contrast, in the fluid device drive method according to the embodiment of the present disclosure, even when a manufacturing error is included in the flow path width of the fluid device, it is possible to search for a frequency at which a standing wave can be formed with respect to the flow path width, and the efficiency of capturing fine particles is improved.

It is desirable that the fluid device drive method according to this aspect be such that in the first search step, a first deviation amount, which is a deviation amount between the reference position and a position of a node or an antinode of the first standing wave, is calculated, and the first frequency is searched for based on a difference between the first deviation amount and a predetermined first reference deviation amount.

By this, it is possible to search for the first frequency capable of forming the first standing wave, where the position of the node or the antinode appears at a position close to the reference position.

It is desirable that the fluid device drive method according to this aspect be such that in the second search step, a second deviation amount, which is a deviation between the position of a node or an antinode of the second standing wave and the position of a node or an antinode of the first standing wave formed at the searched first frequency, is calculated, and the second frequency is searched for based on a difference between the second deviation amount and a predetermined second reference deviation amount.

By this, it is possible to search for the second frequency capable of forming the second standing wave having a node or an antinode close to the fine particle capture position of the first standing wave.

It is desirable that the fluid device drive method according to this aspect be such that the second reference deviation amount is set based on a wavelength of ultrasonic waves forming the first standing wave.

By this, the second standing wave can be formed so as to suppress the diffusion of fine particles when the fine particles flow from the inflow flow path into the separation flow path.

It is desirable that the fluid device drive method according to this aspect be such that in the second search step, when the second deviation amount is larger than the second reference deviation amount, an order of the second standing wave is increased to search for the second frequency.

By this, by using the second standing wave with a higher order, the interval between the nodes or antinodes can be reduced, and the second standing wave with a node or antinode close to the position of the node or antinode of the first standing wave where fine particles are trapped can be searched for.

It is desirable that the fluid device drive method according to this aspect be such that the fluid device further includes a third ultrasonic element that is disposed in the first outflow flow path and that forms a third standing wave in the first outflow flow path toward the second direction, and the first outflow flow path is provided at a position facing the inflow flow path, a third search step is further implemented of searching for a third frequency of the third standing wave at which a node or an antinode is located within the allowable range from the reference position, and in the drive step, the third ultrasonic element is driven at the searched third frequency.

By this, the fine particles captured at the node or antinode of the second standing wave in the separation flow path can be captured at the node or antinode of the standing wave in the first outflow flow path and caused to flow, thereby improving the capturing efficiency of fine particles. Even if a manufacturing error is included in the flow path width of the first outflow flow path, it is possible to search for a frequency at which standing waves can be formed with respect to the flow path width, and thus the capturing efficiency of fine particles is improved.

It is desirable that the fluid device drive method according to this aspect be such that in the third search step, a third deviation amount, which is the deviation between the position of a node or an antinode of the third standing wave and the position of a node or an antinode of the second standing wave formed at the searched second frequency, is calculated, and the third frequency is searched for based on a difference between the third deviation amount and a predetermined third reference deviation amount.

By this, it is possible to search for the third frequency capable of forming the third standing wave having a node or an antinode close to the fine particles capture position of the second standing wave.

It is desirable that the fluid device drive method according to this aspect be such that the third reference deviation amount is set based on wavelength of the ultrasonic waves forming the second standing wave.

By this, the third standing wave can be formed so as to suppress the diffusion of fine particles when the fine particles flow into the first outflow flow path from the separation flow path.

A fluid device according to a second aspect of the present disclosure is a fluid device for separating fine particles in a fluid using ultrasonic waves, the fluid device including an inflow flow path through which fluid flows in a first direction, a separation flow path into which fluid flows from the inflow flow path, and a first outflow flow path for allowing the fluid to flow out from the separation flow path, a second outflow flow path for allowing the fluid to flow out from the separation flow path, a first ultrasonic element that is disposed in the inflow flow path and that forms a first standing wave in the inflow flow path in a second direction orthogonal to the first direction, a second ultrasonic element that is disposed in the separation flow path and that forms a second standing wave in the separation flow path in the second direction, a controller configured to control drive of the first ultrasonic element and the second ultrasonic element, wherein the controller sets a reference position of a node or an antinode of standing waves in the second direction, searches for a first frequency of the first standing wave at which the node or the antinode is positioned within a predetermined allowable range from the reference position, searches for a second frequency of the second standing wave at which the node or the antinode is positioned within the allowable range from the reference position, drives the first ultrasonic element at the searched first frequency, and drives the second ultrasonic element at the searched second frequency.

By this, as in the first aspect, it is possible to control the behavior of fine particles immediately before the fine particles are trapped at the position of the node or antinode of the standing waves in the separation flow path, and to improve the trapping efficiency of fine particles. Even when manufacturing errors and the like affect the flowpathwidth of the fluiddevice, it is possible to search for a frequency at which standing waves can be formed in relation to the flow path width, thereby enhancing the capture efficiency of fine particles.

What is claimed is:

1. A fluid device drive method for a fluid device, the fluid device including
an inflow flow path through which fluid flows in a first direction,
a separation flow path into which is introduced fluid from the inflow flow path and that is configured to capture fine particles in the fluid using a standing wave,
a first outflow flow path through which first fluid having a higher content of fine particles than the fluid flows out,
a second outflow flow path through which second fluid having a lower content of fine particles than the fluid flows out,
a first ultrasonic element that is disposed in the inflow flow path and that forms a first standing wave in the inflow flow path in a second direction orthogonal to the first direction, and
a second ultrasonic element that is disposed in the separation flow path and that forms a second standing wave in the separation flow path in the second direction,
the fluid device drive method comprising execution of:
a reference setting step of setting a reference position in the second direction of a node or an antinode of a standing wave;
a first search step of searching within a predetermined range from the reference position for a first frequency of the first standing wave at which a node or an antinode is located;
a second search step of searching within the range from the reference position for a second frequency of the second standing wave at which a node or an antinode is located; and
a drive step of driving the first ultrasonic element at the first frequency and driving the second ultrasonic element at the second frequency.

2. The fluid device drive method according to claim 1, wherein
in the first search step, a first deviation amount, which is a deviation amount between the reference position and a position of a node or an antinode of the first standing wave, is calculated, and the first frequency is searched for based on a difference between the first deviation amount and a predetermined first reference deviation amount.

3. The fluid device drive method according to claim 1, wherein
in the second search step, a second deviation amount, which is a deviation between the position of a node or an antinode of the second standing wave and the position of a node or an antinode of the first standing wave formed at the first frequency, is calculated, and the second frequency is searched for based on a difference between the second deviation amount and a predetermined second reference deviation amount.

4. The fluid device drive method according to claim 3, wherein
the second reference deviation amount is set based on a wavelength of ultrasonic waves forming the first standing wave.

5. The fluid device drive method according to claim 3, wherein
in the second search step, when the second deviation amount is larger than the second reference deviation amount, an order of the second standing wave is increased to search for the second frequency.

6. The fluid device drive method according to claim 1, wherein
the fluid device further includes a third ultrasonic element that is disposed in the first outflow flow path and that forms a third standing wave in the first outflow flow path toward the second direction, and the first outflow flow path is provided at a position facing the inflow flow path,
a third search step is further implemented of searching for a third frequency of the third standing wave at which a node or an antinode is located within the range from the reference position, and
in the drive step, the third ultrasonic element is driven at the third frequency.

7. The fluid device drive method according to claim 6, wherein
in the third search step, a third deviation amount, which is the deviation between the position of a node or an antinode of the third standing wave and the position of a node or an antinode of the second standing wave formed at the second frequency, is calculated, and the third frequency is searched for based on a difference between the third deviation amount and a predetermined third reference deviation amount.

8. The fluid device drive method according to claim 7, wherein
the third reference deviation amount is set based on wavelength of the ultrasonic waves forming the second standing wave.

9. A fluid device for separating fine particles in a fluid using ultrasonic waves, the fluid device comprising:
an inflow flow path through which fluid flows in a first direction,
a separation flow path into which fluid flows from the inflow flow path, and
a first outflow flow path for allowing the fluid to flow out from the separation flow path,
a second outflow flow path for allowing the fluid to flow out from the separation flow path,
a first ultrasonic element that is disposed in the inflow flow path and that forms a first standing wave in the inflow flow path in a second direction orthogonal to the first direction,
a second ultrasonic element that is disposed in the separation flow path and that forms a second standing wave in the separation flow path in the second direction, and
a controller configured to control drive of the first ultrasonic element and the second ultrasonic element, wherein
the controller sets a reference position of a node or an antinode of standing waves in the second direction, searches for a first frequency of the first standing wave at which the node or the antinode is positioned within a predetermined range from the reference position, searches for a second frequency of the second standing wave at which the node or the antinode is positioned within the range from the reference position, drives the first ultrasonic element at the first frequency, and drives the second ultrasonic element at the second frequency.
